(19) United States
(12) Patent Application Publication
(10) Pub. No.: US 2007/0222133 A1
(43) Pub. Date: Sep. 27, 2007

(54) Method and Device for Centring Semi-Finished Parts Which are to Undergo Mechanical Machining

(76) Inventor: Roberto Sammartin, Selvazzano Dentro (PD) (IT)

Correspondence Address: RATNERPRESTIA, P O BOX 980, VALLEY FORGE, PA, 19482-0980, US

(21) Appl. No.: 11/547,596

(22) PCT Filed: Apr. 8, 2004
(86) PCT No.: PCT/IT04/00187

§ 371 Date: Oct. 4, 2006

(51) Int. Cl. B23Q 3/18

(52) U.S. Cl. 269/139

(57) ABSTRACT

A method is provided for centring semi-finished parts which are to undergo mechanical machining, including the steps of preparing a centring device including three centring elements spaced apart angularly at a regular pitch, capable of coming into contact with the semi-finished part to move it into a centred position, each of the centring elements being movable along a preset radial direction (Y), the radial directions intersecting at geometrical axis (X) for centring the part. The method further provides for the steps of moving each centring element along the corresponding radial direction (Y), with controlled and independent movement of each centring element relative to the others, by a respective drive associated with a respective apparatus for transmitting the motion capable of converting the rotational motion of each drive into translational motion of the corresponding centring element, and of adjusting the position of each centring element as a function of the torque developed by the respective drive, until a condition of centring is reached in which all the torque forces developed by the drives of the corresponding centring elements are greater than or equal to a preset threshold value indicating that a desired centring position of the part relative to the geometrical axis (X) of the centring device has been reached. A centring device operating according to the above-mentioned method is also described.

This application is a U.S. National Phase Application of PCT International Application PCT/IT2004/000187 and incorporated by reference herein.

1. Technical Field

The present invention relates, in general, to a method and device for centring semi-finished parts which are to undergo mechanical machining,and more particularly to such method and device having spaced apart centring elements spaced apart angularly at a regular pitch.

2. Technological Background

The invention falls particularly, though not exclusively, within the specific technical field of centring semi-finished parts which are to undergo mechanical machining, for example turning or other surface finishing operations, for the purpose of centring a part relative to the geometrical axis of rotation of the fixtures for securing the workpiece typically provided in conventional machining centres. Although the invention can be used in any type of machining centre requiring the centring of semi-finished products with substantially axially symmetric geometry, it has been designed with particular reference to the centring of semi-finished vehicle wheels of light alloy, particularly aluminium alloy, the term “wheel” being used to denote the entire rim and wheel structure, generally obtained as a semi-finished casting which then undergoes subsequent mechanical machining operations of turning and surface finishing.

For this purpose centring of the semi-finished part is required, an operation which is commonly carried out by means of a three-point centring device in which three centring units equipped with jaws, arranged 120° degrees apart, are moved along guides which are radial relative to the geometrical axis of the device to lock the semi-finished product in a centred position. A typical known application makes provision for the three jaws to be self-centring, that is connected to each other by gearing so that their movement is synchronised (with the same travel to and from the axis of the device) along said directions, and consequently lock the part in a centred position relative to the geometrical axis of the centring device.

### BRIEF DESCRIPTION OF THE INVENTION

A main aspect of the present invention is to make available a method and device for centring semi-finished products which offers greater versatility for the centred positioning of semi-finished parts, for example by enabling parts of different dimensions and sizes to be centred without requiring replacement of the centring components and at the same time providing speed and reliability and also accuracy in the centred positioning of the part.

Another aspect is to define a method and a centring device which enables the roundness characteristic of the semi-finished product to be measured at the centring points so that the part may be scrapped in the event that the value measured exceeds a pre-established tolerance threshold.

Yet another aspect is to produce a centring method and device such as to improve accessibility to the part once it is arranged in a centred position, to facilitate and speed up all the operations required in the subsequent steps of mechanical machining.

The present invention relates to a method for centring semi-finished parts which are to undergo mechanical machining, comprising the steps of:

preparing a centring device including three centring elements spaced apart angularly at a regular pitch, capable of coming into contact with the semi-finished part to move it to a centred position, each of said centring elements being movable along a preset radial direction (Y), said radial directions intersecting each other at a geometrical axis (X) for centring the part,

moving each centring element along the corresponding radial direction (Y), with controlled and independent moving of each centring device relative to the others, by respective drive means associated with respective means of transmitting motion capable of converting rotation motion of each drive means into translational motion of the corresponding centring element, and

adjusting the position of each centring device as a function of torque developed by the respective drive means until a centring condition is reached in which all the torque forces developed by the drive means of the corresponding centring elements are greater than or equal to a preset threshold value indicating that a desired centring position of the part relative to the geometrical axis (X) of the centring device has been reached.

The present invention also relates to a device for centring semi-finished parts which are to undergo mechanical machining including three centring elements spaced apart angularly at a regular pitch and movable along respective pre-defined radial directions (Y) intersecting at a geometrical axis (X) for centring of the part. The device also includes drive means associated with each of the centring units operated independently of each other, and means of transmitting motion associated with each drive means to convert rotational motion of the drive means into translational motion of the centring elements. Also included are means of measuring torque developed by the respective drive means following contact of the corresponding centring unit with the part, and means of comparing torque values measured with preset threshold values to control the movement of the centring elements as a function of the torque values measured and halting the centring elements upon reaching a desired centring condition.

### BRIEF DESCRIPTION OF THE DRAWINGS

The characteristics and advantages of the invention will become clear from the following detailed description of a preferred example of embodiment, provided purely by way of non-limiting example, with reference to the appended drawings in which:

FIG. 1 is a schematic view in front elevation of a centring device operating according to the method disclosed by the present invention,

FIG. 2 is a schematic plan view of the device in FIG. 1,

FIG. 3 is a view at an enlarged scale of a detail of the preceding drawings, identified by the arrow A in FIG. 1.

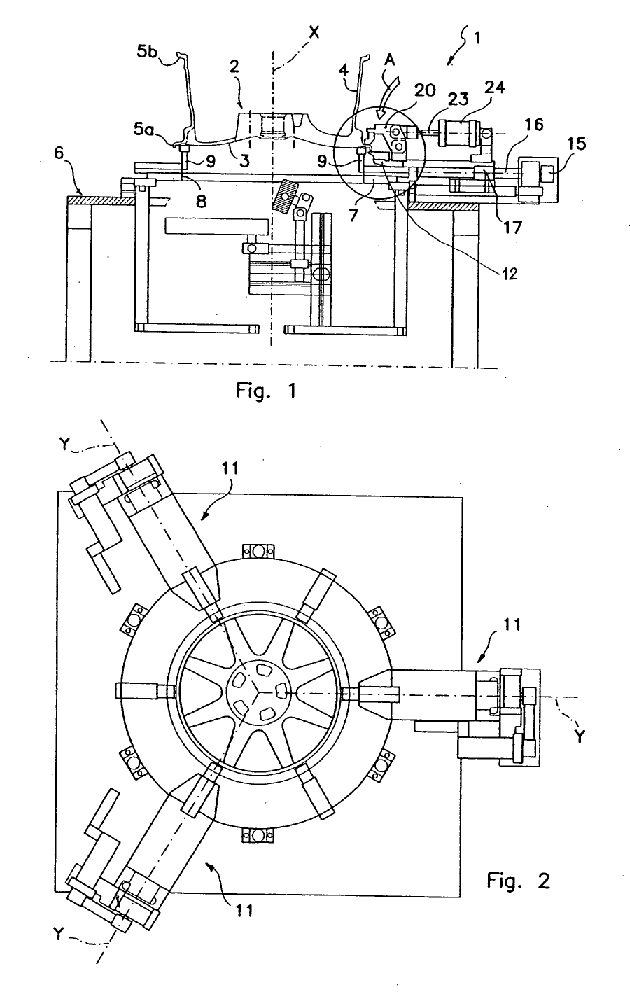

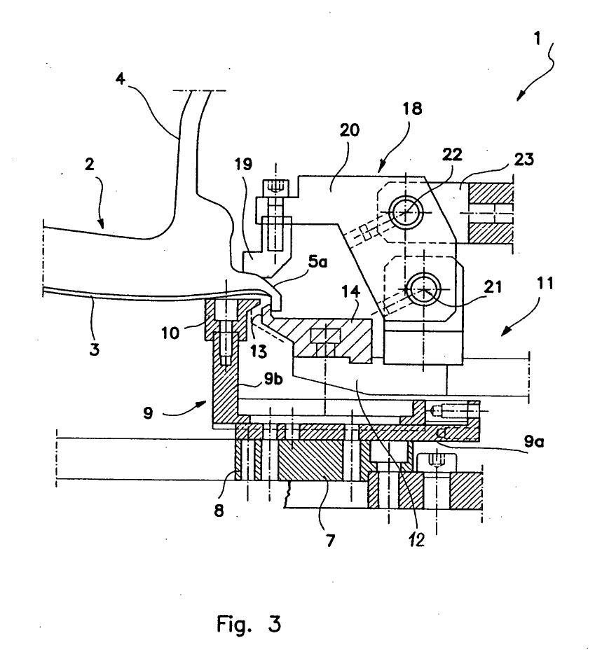

### PREFERRED MODE OF EMBODIMENT OF THE INVENTION

With reference to the drawings cited, the number 1 indicates as a whole a device for centring semi-finished parts arranged to undergo subsequent mechanical machining, operating according to the method disclosed by the present invention. This method is described in what follows with particular reference to semi-finished vehicle wheels 2 of light alloy, in particular aluminium alloy, it being understood that this application represents a preferred non-limiting choice, the invention being applicable just as effectively in all cases where there is a requirement to centre parts having an axially symmetric form of geometry.

Moreover, the term “wheel” is used in the present context to denote the whole structure of a rim and wheel for vehicles, typically having a front portion 3 arranged to be drilled (with the provision of through holes for attaching the wheel to the vehicle hub) from which there rises a wall 4 of cylindrical form having opposite edges 5a, 5b which are circumferential and also project radially to form the surface for fitting the tire to the wheel.

The device 1 comprises a frame with supporting structure 6 on which is mounted a plate 7 having a central through opening 8. Also rising from the plate 7 are a plurality of support elements 9 designed to constitute seatings for the wheel 2, as will become clear in what follows. The support elements 9 are arranged circumferentially at a regular angular pitch and can be moved in an adjustable manner along directions which are radial relative to the geometrical central axis of the device, indicated by X in the drawings. In this way, the seating points for the wheel 2 on the supports are adjustable for limited radial travel. The adjustability of the supports enables semi-finished products of different diameters to be accommodated in the device, within a pre-selected range of values. More particularly, each support element 9 comprises a first portion 9a guided on the plate 7 and capable of being secured to it, for example by screw means, and a second portion 9b, rising at right angles from the first portion 9a comprising at the free end a head 10 for the seating contact with the wheel 2, in particular to provide seating for the front portion 3 of the wheel in a circumferential area close to the edge 5a.

A preferred choice provides for the arrangement of six support elements 9 fitted at a regular angular pitch to the plate 7. The heads 10 therefore form seating surfaces for the wheel 2 forming as a whole an imaginary seating plane in which the wheel has limited freedom of movement.

The device 1 is also provided with three centring elements, all indicated by the number 11, arranged at 120° from each other and each comprising a respective slide 12 guided radially relative to the axis X. The radial directions of the centring units 11, indicated by the axes Y in FIG. 2, are conveniently offset at an angle relative to the directions of radial movement of the support elements 9 to avoid interference when the device is operating.

The centring units 1 are structurally identical and therefore only one of them will be described in detail in what follows.

The slide 12 comprises at one of its ends a projection 13 having an extension such as to bear against the edge 5a of the wheel as a result of the radial movement of the slide and which is therefore capable of pulling the wheel away from the axis X. The projection 13 may conveniently constitute the end of a small block 14 removably attached to the slide 12.

For the movement of each slide 12 a respective motor 15 is provided (the motors being operated independently of each other) associated with respective transmission means capable of converting the rotational motion of the motor 25 into a translational movement of the slide 12. Each slide 12 is also provided with means for measuring its position (not shown), for example of the encoder type for measuring the distance travelled as a function of the rotation of the motor.

More particularly, provision is made for each motor 15 to drive in rotation a threaded spindle 16 which is engaged with a suitable coupling in a female thread made internally in a bush formation 17 integral with the slide 12. In this way, for a preset angular rotation of the motor 15 (and therefore of the spindle 16) a corresponding translational movement of the bush 17 (and therefore of the slide 12) is generated along the corresponding radial direction Y.

Also provided on each slide 12 are means 18 for locking the part being centred, which comprise a locking foot 19 attached to an arm 20 hinged at 21 to the slide 12. Also hinged to the arm 20 at 22 is the end of the operating spindle 23 of a jack 24 fitted on board the slide 12. By means of the lever arm formed between the hinging points 21 and 22, the locking foot 19 is moved away from and towards an operating position in which it is pressed onto the wheel 2 at the edge 5a in order to provide relative locking for it.

The method of centring according to the invention provides for the semi-finished wheel 2 initially to be seated on the support elements 9 with the heads 10 and the front portion 3 of the wheel in contact with each other. In this step the centring elements 11 are moved back towards the axis X with equal radial positioning relative to this axis, but such that the projections 13 are positioned between the axis X and the peripheral edge 5 of the wheel.

It should be noted that in this step the semi-finished wheel 2 is positioned on the supports 9 simply by seating, possibly with an offset between the axis X and the geometrical axis of axial symmetry of the wheel, centring being obtained subsequently as made clear in what follows.

In a subsequent step provision is made for the three centring units 11 to be moved along the respective radial directions Y away from the axis X, synchronised with each other, by operation of the respective motors 15. Preferably the motors selected are of the controlled movement type, so that rotation of the motor 15 and consequently the translational travel of the respective slide 12 associated with it can be accurately controlled and adjusted.

The method disclosed by the invention also makes provision for measuring the torque developed by each motor 15 in the radial travel of each centring unit 11 between the initial non-operating condition and the condition in which the projection 13 bears against the edge 5a of the wheel, until the wheel reaches a centred position.

Assuming that the part is in a centred condition, by reason of the axial symmetry and the relative arrangement of the centring units, the torque developed by the three motors must be substantially equal, for reasons of general symmetry of the system, and the position reached is that in which the wheel is centred relative to the geometrical axis X.

According to the invention, provision is made to preset a torque value defining a threshold which, when reached (or exceeded) in all three motors 15 of the corresponding centring devices 11, is an indication that a centring condition has been reached. The pre-selected value of the above-mentioned threshold must clearly take account of and be greater than those torque values (or ranges of values) necessarily developed to overcome friction and inertia encountered by the centring units 11 in the process of moving the wheel until the centred position is reached.

In this step it may happen that one or two centring units 11 reach the wheel first and bear against and move it relative to the others. In this case, the resisting torque developed by these centring units 11 is in any case less than the pre-selected threshold value and therefore the movement of the centring units 11 is continued further until the condition in which all three centring units bear against the wheel at the respective centring points and the resisting torque generated by the motors 15 increases until the preset threshold is reached (and possibly exceeded). When this condition is reached, the movement of the centring units 11 is halted and the locking means 18 are activated with each foot 19 swinging onto the wheel 2 to bear against the wheel at a preset pressure (generated by the jack 24) in opposition to the reaction exerted by the support elements 9.

According to the invention, it is also possible to measure the positioning distances reached in the respective amounts of travel of the three centring units (by means of the above-mentioned measuring means) and to check whether the differences calculated fall within a preset range of tolerance values. If they do, the machining cycle may continue as usual or may be repeated with a different orientation of the wheel, as made clear in what follows, or the wheel may be scrapped.

Provision may also be made to measure the values of the torque developed by the motors 15 at pre-selected intervals of time or space in the travel of each centring unit until the centring condition is reached in which all the torque values measured are equal to or greater than the pre-established threshold value. In this connection, an electronic unit may conveniently be arranged to receive as input the signals corresponding to the torque values measured on the three motors, comparing these signals with the pre-selected threshold value and generating signals to halt the centring unit if necessary depending on the outcome of the comparison made.

In a further step in the method, where appropriate devised in addition to the above-mentioned main steps, provision may be made to halt the centring units, return these to the initial non-operating condition (close to the X axis) and repeat the centring steps after the wheel 2 has been given a different orientation about its geometrical axis, by rotating the wheel by a preselected angle. This method may conveniently be used when, because of marked distortion in the semi-finished product, the centring position is not reached within the limits of the permissible radial travel of the centring units. This is because it may happen that two centring units reach and bear against the wheel, but the third, assuming that there is marked distortion of the wheel, does not manage to bear against the wheel before the two above-mentioned centring units reach a position which is the limit of permissible radial travel. In this case, provision may be made to allow the third centring unit to travel a further preset amount (depending on the permissible tolerance), and when this is reached, the resisting torque associated with it is measured once again. Depending on the torque value measured, the centring obtained may be accepted or, if not, the wheel is given a new orientation or is scrapped because of unacceptable distortion or defective roundness.

The outcome of this is that a new angular orientation of the wheel (by means of pre-selected rotation about the axis of the wheel) may provide a different, more accurately centred position for the semi-finished product. Further changes in the orientation of the wheel may be tried, with the centring steps being repeated, if centring is difficult to achieve in a single positioning attempt by reason of particular distortion (generated in the casting process) present in the semi-finished product.

It should be noted how the centring device operating according to the method disclosed by the invention may be built to a size such as to ensure ample accessibility to the semi-finished product, in particular to the front portion 3 of the wheel, through the central opening 8 in the support frame 6. This accessibility is also shown to be advantageous if holes have to be drilled at the edge of the wheel 5a for assembling the front portion 3 to the cylindrical body of the wheel (the wall 4 and edges 5a, 5b) where these parts begin as structurally independent and are subsequently assembled.

This easier accessibility therefore makes it possible to perform successive steps in mechanical machining of the part with particular rapidity and without requiring further positioning of the semi-finished product.

The invention thus achieves the proposed aims, offering numerous advantages compared with known solutions.

A principal advantage lies in the fact that with the centring method and device according to the invention, improved flexibility and versatility are obtained in the operations of centring semi-finished parts, in particular obtaining speed and accuracy in placing parts in a centred position even where there are relative differences in dimensions and sizes between the parts (for example wheels having different diameters).

Another advantage consists in the improved accessibility to the semi-finished part offered by the invention which makes it possible, among other things, to carry out drilling in the peripheral area of the flange (at the edge close to the front portion) to produce the attachment holes in the case of wheels produced in two parts.

Another advantage still lies in the improved accuracy obtainable in centring the part because of the possibility of rapidly repeating the steps in centring the part starting from a different orientation of the part, thus achieving greater overall accuracy.

1. A method for centring semi-finished parts which are to undergo mechanical machining, comprising the steps of:
preparing a centring device including three centring elements spaced apart angularly at a regular pitch, capable of coming into contact with the semi-finished part to move it to a centred position, each of said centring elements being movable along a preset radial direction (Y), said radial directions intersecting each other at a geometrical axis (X) for centring the part,
moving each centring element along the corresponding radial direction (Y), with controlled and independent moving of each centring device relative to the others, by respective drive means associated with respective means of transmitting motion capable of converting rotation motion of each drive means into translational motion of the corresponding centring element, and
adjusting the position of each centring device as a function of torque developed by the respective drive means until a centring condition is reached in which all the torque forces developed by the drive means of the corresponding centring elements are greater than or equal to a preset threshold value indicating that a desired centring position of the part relative to the geometrical axis (X) of the centring device has been reached.

2. The method of centring according to claim 1 in which said centring elements are moved along said respective radial directions (Y) away from the geometrical axis (X) of the device towards a position where they bear against the semi-finished part to move it along the respective radial direction until the centring position is reached.

3. The method according to claim 1, in which the centring elements are moved in synchronism along the respective directions of radial movement away from the geometrical axis, so that equal radial movement occurs simultaneously along the respective directions.

4. The method according to claim 3, including the step of measuring the torque developed at each drive means associated with the respective centring element during the operating travel of the latter, and also the step of comparing the torque values measured with said preset threshold value, so as to halt the movement of the centring elements upon reaching the condition in which all three torque values measured are equal to or greater than the preset threshold value.

5. The method according to claim 1, including the step of halting the movement of the centring elements upon reaching the condition in which the preset threshold value is not reached by all three centring devices within a pre-selected time interval, or within a pre-selected radial travel of the centring devices, and the step of repeating the sequence of movement of the centring units, after the part has first been rotated angularly about its main axis by a pre-selected angle.

6. The method according to claim 1, prior to the movement of the centring elements, including the step of seating the part on a plurality of support elements arranged to allow limited freedom of movement of the part in a plane perpendicular to the geometrical axis of the device.

7. The method according to claim 6, in which said support elements are spaced apart angularly relative to the angular position of the centring elements.

8. The method according to claim 6, including the step of locking the part once the desired centring position is reached, at the area of contact between each centring element and the part, by means of locking forces exerted in opposition to the reaction of said support elements.

9. A device for centring semi-finished parts which are to undergo mechanical machining comprising three centring elements operating according to the method of claim 1.

10. A device for centring semi-finished parts which are to undergo mechanical machining comprising three centring elements spaced apart angularly at a regular pitch and movable along respective pre-defined radial directions (Y) intersecting at a geometrical axis (X) for centring of the part, drive means associated with each of said centring units operated independently of each other, means of transmitting motion associated with each drive means to convert rotational motion of the drive means into translational motion of the centring elements, means of measuring torque developed by the respective drive means following contact of the corresponding centring unit with the part and means of comparing torque values measured with preset threshold values to control the movement of the centring elements as a function of the torque values measured and halting the centring elements upon reaching a desired centring condition.

11. The device according to claim 10, further comprising means for measuring the positioning distance covered by each centring element in the travel along the respective radial direction.

12. The device according to claim 10, in which said centring elements each comprise a respective slide guided along the corresponding radial direction (Y), at least one projection being provided on each slide capable of bearing against edge portions of the part to move the part away from the geometrical axis (X) of the device during the travel of the centring elements until the condition of centring of the part is reached.

13. The device according to claim 10, in which said means for transmitting motion comprise a screw-nut coupling between a threaded spindle and a bush formation engaged with the spindle as a screw drive, said spindle and bush being integral with one and the other of said respective drive means and slide of the centring unit to convert the rotational motion of the motor into translational movement of the slide.

14. The device according to claim 12, comprising in each slide means of locking the part including a locking foot hinged to the respective slide and capable of being swung away from and towards a position where the part is locked.

15. The device according to claim 14 in which jack operating means are provided acting on each locking foot to swing the foot away from and towards the locking position on the part.

16. The method according to claim 2, in which the centring elements are moved in synchronism along the respective directions of radial movement away from the geometrical axis, so that equal radial movement occurs simultaneously along the respective directions.

17. The method according to claim 2, including the step of halting the movement of the centring elements upon reaching the condition in which the preset threshold value is not reached by all three centring devices within a pre-selected time interval, or within a pre-selected radial travel of the centring devices, and the step of repeating the sequence of movement of the centring units, after the part has first been rotated angularly about its main axis by a pre-selected angle.

18. The method according to claim 3, including the step of halting the movement of the centring elements upon reaching the condition in which the preset threshold value is not reached by all three centring devices within a pre-selected time interval, or within a pre-selected radial travel of the centring devices, and the step of repeating the sequence of movement of the centring units, after the part has first been rotated angularly about its main axis by a pre-selected angle.

19. The method according to claim 4, including the step of halting the movement of the centring elements upon reaching the condition in which the preset threshold value is not reached by all three centring devices within a pre-selected time interval, or within a pre-selected radial travel of the centring devices, and the step of repeating the sequence of movement of the centring units, after the part has first been rotated angularly about its main axis by a pre-selected angle.

20. The method according to claim 2, prior to the movement of the centring elements, including the step of seating the part on a plurality of support elements arranged to allow limited freedom of movement of the part in a plane perpendicular to the geometrical axis of the device.

21. The method according to claim 3, prior to the movement of the centring elements, including the step of seating the part on a plurality of support elements arranged to allow limited freedom of movement of the part in a plane perpendicular to the geometrical axis of the device.

22. The method according to claim 4, prior to the movement of the centring elements, including the step of seating the part on a plurality of support elements arranged to allow limited freedom of movement of the part in a plane perpendicular to the geometrical axis of the device.

23. The method according to claim 5, prior to the movement of the centring elements, including the step of seating the part on a plurality of support elements arranged to allow limited freedom of movement of the part in a plane perpendicular to the geometrical axis of the device.

24. A device for centring semi-finished parts which are to undergo mechanical machining comprising three centring elements operating according to the method of claim 2.

25. A device for centring semi-finished parts which are to undergo mechanical machining comprising three centring elements operating according to the method of claim 3.

26. A device for centring semi-finished parts which are to undergo mechanical machining comprising three centring elements operating according to the method of claim 4.

27. A device for centring semi-finished parts which are to undergo mechanical machining comprising three centring elements operating according to the method of claim 5.

28. A device for centring semi-finished parts which are to undergo mechanical machining comprising three centring elements operating according to the method of claim 6.

29. A device for centring semi-finished parts which are to undergo mechanical machining comprising three centring elements operating according to the method of claim 7.

30. A device for centring semi-finished parts which are to undergo mechanical machining comprising three centring elements operating according to the method of claim 8.

31. The device according to claim 11, in which said centring elements each comprise a respective slide guided along the corresponding radial direction (Y), at least one projection being provided on each slide capable of bearing against edge portions of the part to move the part away from the geometrical axis (X) of the device during the travel of the centring elements until the condition of centring of the part is reached.

32. The device according to claim 11, in which said means for transmitting motion comprise a screw-nut coupling between a threaded spindle and a bush formation engaged with the spindle as a screw drive, said spindle and bush being integral with one and the other of said respective drive means and slide of the centring unit to convert the rotational motion of the motor into translational movement of the slide.

33. The device according to claim 12, in which said means for transmitting motion comprise a screw-nut coupling between a threaded spindle and a bush formation engaged with the spindle as a screw drive, said spindle and bush being integral with one and the other of said respective drive means and slide of the centring unit to convert the rotational motion of the motor into translational movement of the slide.
